(19) United States
(12) Patent Application Publication
(10) Pub. No.: US 2008/0229945 A1
(43) Pub. Date: Sep. 25, 2008

(54) Spray dampening valve having associated electronic adjustment and correction data

(76) Inventors: Michael A. Niemiro, Plainfield, IL (US); Robert Magyar, EIk Grove Village, IL (US); Corey Hill, Chicago, IL (US)

Correspondence Address: PATTI, HEWITT & AREZINA LLC, ONE NORTH LASALLE STREET, 44TH FLOOR, CHICAGO, IL, 60602, US

(21) Appl. No.: 11/728,128

(22) Filed: Mar. 24, 2007

(51) Int. Cl. B41L 25/06

(52) U.S. Cl. 101/147

(57) ABSTRACT

An embodiment of the present method and apparatus may have: a spraybar assembly having a plurality of spray valves; a unique identification associated with the spraybar assembly; response profile having a plurality of characteristic profiles, characteristic profiles of the plurality of characteristic profiles correspondingly respectively to spray valves of the plurality of spray valves; and the response profile being associated with the spraybar assembly.

### TECHNICAL FIELD

The invention relates generally to dampening spray systems in offset printing processes and, more specifically, to spray dampening valves in the dampening spray systems.

### BACKGROUND

In the offset printing process, a small amount of a dampening solution, i.e., water with certain additives, is supplied to the offset plate, which then comes in contact with the inking rollers, the ink adhering to the image on the plate and the dampening solution adhering to the other portions of the plate. The quantity and placement of the dampening solution must be varied for different types and densities of ink, variations in printing densities and ink coverage, and press speed. Control of the application of the dampening fluid is particularly important in four-color process, where variations will affect color. If too little fluid is applied, printing will occur in areas where none is desired. If too much fluid is applied, printing may not occur in some areas, or image density may drop.

Various systems for dampening the plate cylinder of an offset printing apparatus are in use today. One such system employs dampening rollers which rotate partially within an open trough containing dampening fluid. The dampening rollers bear directly or indirectly against the plate cylinder, thereby supplying a film of dampening fluid to the plate cylinder. This system, however, suffers from a number of inherent disadvantages from the standpoint of both operation and maintenance. From the operational standpoint, the system is too imprecise and difficult to control. Frequently, too much or too little solution is applied to the plate roller, or at least to certain areas of the plate roller, reducing the printing quality.

Another known dampening system eliminates the open fluid container and the immersed dampening roll, and replaces them with a closed system which pumps dampening fluid as a spray onto a dampening roll train for application to the plate cylinder. In such a spray dampening system, the dampening fluid is sprayed onto the press rollers by means of a linear array of spray nozzles with the spray patterns of the individual nozzles merging to form a continuous composite spray pattern across the surface of the press roller. It is important in obtaining proper dampening that the distribution of dampening fluid be as uniform as possible. There should be no starved areas where the amount of dampening fluid is substantially less than the other areas on the surface of the roller, and the overlapping of the adjacent individual spray patterns should be minimized so that there is little or no excessive dampening fluid applied to any portion of the dampening roller.

Various attempts have been made at adjusting the amount of dampening fluid applied to the dampening roll. In known dampening systems nozzles fluctuate between open and closed positions to regulate the amount of dampening fluid applied to the rolls, nozzles are pulsed on and off with the pulse width and/or frequency being adjusted, dampening fluid is delivered through alternate laterally adjacent nozzles, etc. However, none of the known systems provide for the accuracy and repeatability that is desired for this application.

In approximately 1998, Baldwin/Jimek introduced a means of adjusting the stroke-length of each valve. Each valve had a threaded adjustable stop, and a jam-nut. This allowed the operator to adjust flow-rate for given conditions. Association between this mechanical compensation and the spraybar was accomplished in this system. However, it is not purely electronic.

In approximately 1996, Smith RPM Corporation provided a means of manually creating corrections to equalize the flow-rate of each valve. These corrections were stored in the spraybar controller. As such, the corrections were associated with the location within the system not the spraybar. When a new spraybar is installed, the calibration procedure must be repeated. Our embodiments differ in that they are automated, and associated with the spraybar, not the location in the system.

In approximately 1999 the press control company EAE (Ewert Ahrensburg Electronik GmBH) introduced a system they called “PRINT4”. This system had a provision where final running values (as adjusted by the operator) of all devices were stored and compared to initial (anticipated) set points. After a number of iterations, the system could “learn” the variations, and compensate for them. The “feedback” in PRINT4 is human intervention, which differs greatly from our genuine measured feedback. The “PRINT4” concept associates corrections with location within the system, not the corrected devices.

Therefore, there is a need in the art for an improved and more accurate spray dampening devices for use in the offset printing process. That is, in spray dampening, there has long been a need to establish an absolute volumetric valve output, which is associated with some applied system setpoint “X”. Such that, when setpoint “X” is applied to any spraybar valve, the output is predictable and equal for every spraybar in the dampening system.

### SUMMARY

One embodiment of the present method and apparatus encompasses an apparatus. In this embodiment the apparatus may comprise: a spraybar assembly having a plurality of spray valves; a unique identification associated with the spraybar assembly; response profile having a plurality of characteristic profiles, characteristic profiles of the plurality of characteristic profiles correspondingly respectively to spray valves of the plurality of spray valves; and the response profile being associated with the spraybar assembly.

Another embodiment of the present method and apparatus encompasses a method. This embodiment of the method may comprise: connecting a spraybar assembly having a plurality of valves to a test/calibration apparatus, and monitoring at least one predetermined parameter of each valve of the plurality of valves; operating the plurality of valves of the spraybar assembly by the test/calibration apparatus at predetermined operating parameters while monitoring dynamic characteristics of the plurality of valves; generating via the test/calibration apparatus a respective characteristic profile for each respective valve of the plurality of valves; and storing the characteristic profiles as a response profile of the spraybar assembly in a non-volatile memory on the spraybar assembly.

### DESCRIPTION OF THE DRAWINGS

Features of the embodiments will become apparent from the description, the claims, and the accompanying drawings in which:

FIG. 1 is a schematic drawing of a spray dampening system that incorporates the present method and apparatus;

FIG. 2 is one embodiment of a spraybar assembly for use in the FIG. 1 spray dampening system;

FIG. 3 depicts one embodiment of the spraybar assembly implementation according to the present method and apparatus;

FIG. 4 depicts another embodiment of the spraybar assembly implementation according to the present method and apparatus;

FIG. 5 depicts a further embodiment of the spraybar assembly implementation according to the present method and apparatus;

FIG. 6 depicts yet another embodiment of the spraybar assembly implementation according to the present method and apparatus;

FIG. 7 depicts an additional embodiment of the spraybar assembly implementation according to the present method and apparatus;

FIG. 8 depicts a further embodiment of the spraybar assembly implementation according to the present method and apparatus;

FIG. 9 is a flow diagram depicting in general an embodiment according to the present method.

FIG. 10 is a flow diagram depicting in general an embodiment according to the present method during a calibration phase.

FIG. 11 is a flow diagram depicting in general an embodiment according to the present method during an operation phase.

### DETAILED DESCRIPTION

In the offset printing process, a small amount of a dampening solution, for example water with certain additives, is sprayed onto the offset plate by a plurality of solenoid valves.

In spray dampening, embodiments of the present method and apparatus encompass a spraybar wherein an absolute volumetric valve output is established, which is associated with some applied system setpoint “X”. Such that, when setpoint “X” is applied to any spraybar valve, the output is predictable and equal for every spraybar in the dampening system.

Embodiments of the present method and apparatus encompass an electronic feedback. By employing an electronic sensor(s) in the process, the valve response may be monitored to defined operating parameters significant parameters electronically. This feedback permits imparting varying degrees of automation, in correcting the output of valves demonstrating output variation.

Embodiments of the present method and apparatus also encompass unique associatively. The delivery device (spraybar) in a spray dampening system is a highly portable device. Typically the spraybar will migrate frequently, independently of the control electronics. Correction data/adjustments are unique for every spraybar. It is imperative that any correction data/adjustment move with the spraybar, or be transferred to the spraybar in a manner that maintains this unique relationship.

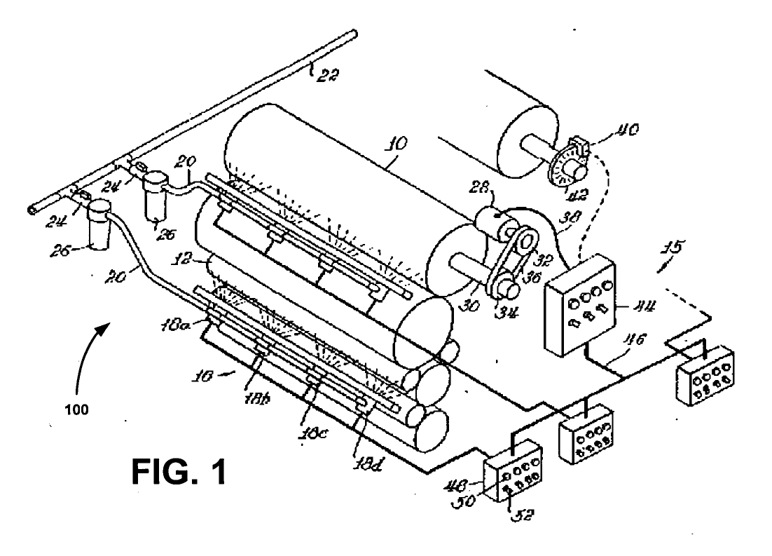

FIG. 1 is a schematic drawing of a spray dampening system that incorporates the present method and apparatus. There is shown a typical printing operation including various rollers such as a plate cylinder 10, and an inking roller 12 both rollers of which require the application of a dampening fluid to the surfaces thereof for the proper transfer of the photoengraved image on the plate cylinder 10 to the paper (not shown).

While different printing operations may require fewer or more rollers than shown in FIG. 1, it is sufficient to realize that irrespective of the particular printing operation the application of spray dampening solution to roller surfaces is required to effect a proper transfer of ink from the offset plate cylinder to the paper medium.

The spray dampening control system, generally designated 15, includes one or more solenoid-operated spray nozzle bars, one shown as reference character 16. In the printing operation, spray bar 16 may include, for example, four solenoid-operated spray nozzles 18a, 18b, 18c, 18d, spaced apart from each other and from the inking roller 12, such that the spray jet emitted from the nozzles uniformly covers the surface of such roller. For the sake of clarity the inking system for applying the oil base ink to the inking roller 12 is not shown.

Each solenoid controlled spray nozzle may have an input plumbed to a liquid supply line 20. The electrically controlled nozzles may be, for example, of a normally off type where the application of an electrical signal opens the nozzle valve to allow the pressurized liquid to be sprayed for the duration of the signal. Ideally electrically controlled nozzles of this type, being either fully on or off, provide a constant angle of spray when activated and thus maintain a constant area of coverage even though the volume of liquid sprayed may be reduced. With this arrangement the volume of liquid sprayed is increased either with an increase in frequency, or by an increase in the duration of the electrical signal. A main liquid supply conduit 22 provides spray dampening fluid at a pressure of about 40-90 pounds to the supply lines 20 through respective shut off valves 24 and filters 26.

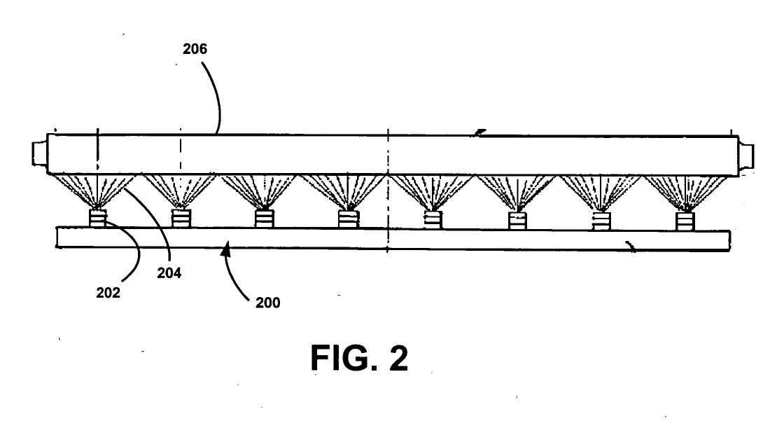

FIG. 2 is one embodiment of a spraybar assembly 200 for use in the FIG. 1 spray dampening system. The spraybar assembly may have a variety of different forms and configurations

Each valve position will be excited under known conditions. The system will electronically evaluate the valve response using a calibration apparatus, which is located off of the press. Then correction factors will be established to equalize the outputs. The system may include the capability of monitoring all influential parameters, such as temperature, pressure, etc. . . . Once the set of correction data is established, it will be uniquely associated with its corresponding spraybar through one of the following (but not limited to) methods. These are listed in order of sophistication.

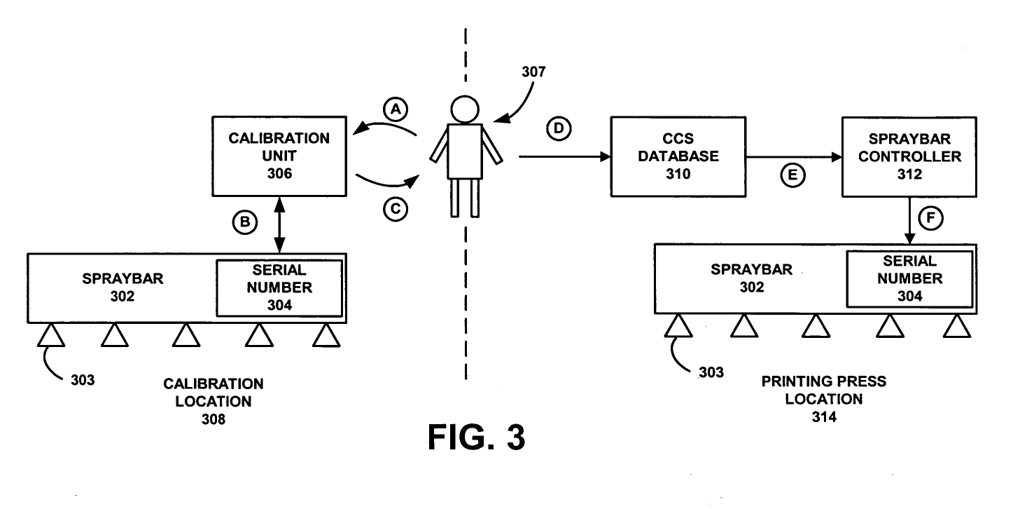

FIG. 3 depicts one embodiment of the spraybar assembly implementation according to the present method and apparatus. A spraybar assembly 302 may have a plurality of valves 303. At a calibration location 308 a calibration unit 306 is operatively coupled to a spraybar assembly 302 having a serial number 304. The serial number 304 may be, for example, in the form of a serial number or other display or code. The calibration unit 306 may also be used to test the spraybar assembly 302, and therefore may also be referred to as a test/calibration apparatus.

The spraybar assembly 302 may have a plurality of valves 303. It is to be understood that the embodiments of the present method and apparatus may utilize valves with or without attached nozzles.

After completion of the calibration phase, the spraybar assembly 302 may be moved from the calibration location 308 to a printing press location 314. The spraybar identifier, for example, the serial number 304, and associated correction data for the spraybar 302 may be manually entered into central control system, for example CCS database 310, by a user 307. A system, such as a printing apparatus, may have many spraybar assemblies. The location of each spraybar in the system may be entered manually into the CCS database 310. In operation, the central control system may deliver respective corrections to a local spraybar controller 312 operating the spraybar 302.

The sequence of events are:

A. Operator 307 visually locates serial number 304 on spraybar assembly 302 and enters it at the CALIBRATION UNIT 306.

B. CALIBRATION UNIT 306 excites spraybar valves 303, analyzes valve response, and generates correction data.

C. Operator 307 reads back serial number 304 and corresponding correction data.

D. Operator 307 enters serial number 304, corresponding correction data, and location within system into CENTRAL CONTROL SYSTEM/DATABASE 310.

E. CENTRAL CONTROL SYSTEM/DATABASE 310 downloads correction data to SPRAYBAR CONTROLLER 312 at printing press location 314.

F. During operation, SPRAYBAR CONTROLLER 312 applies modified electrical signals to the nozzles 303 of the spraybar assembly 302 based on the corresponding correction data.

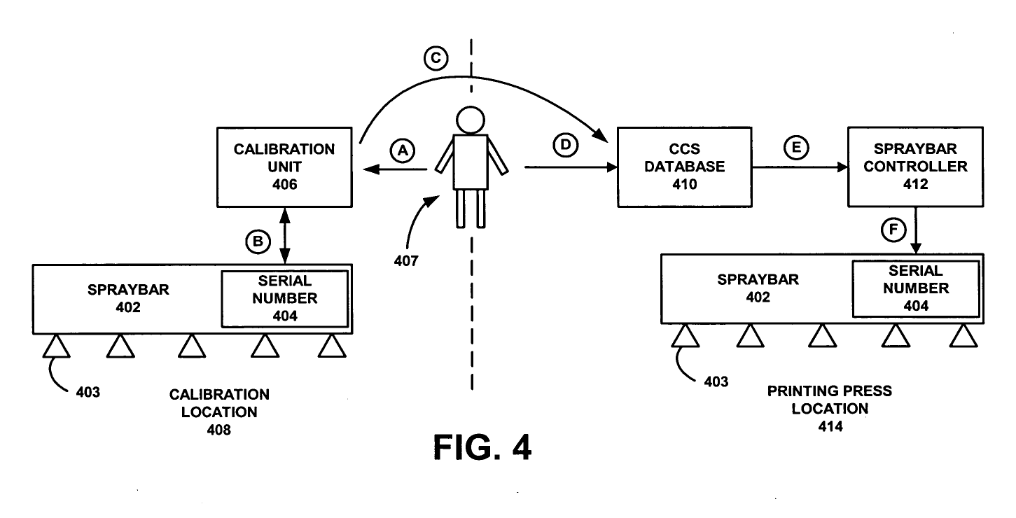

FIG. 4 depicts another embodiment of the spraybar assembly implementation according to the present method and apparatus. This method is similar to the FIG. 3 method, except that there exists a data link between the CALIBRATION UNIT 406 and the CENTRAL CONTROL SYSTEM/DATABASE 410. This eliminates the need for the operator 407 to manually enter the serial number 404 of the spraybar assembly 302 and corresponding correction data at the CENTRAL CONTROL SYSTEM/DATABASE 410.

As previously described, the spraybar assembly 402 may have a plurality of valves 403. At a calibration location 408 the calibration unit 406 is operatively coupled to the spraybar assembly 402 having a serial number 404. The CENTRAL CONTROL SYSTEM/DATABASE 410 may be operatively coupled to a respective spraybar controller 412 that operates the spraybar 402 in the printing press location 414.

The sequence of events is:

A. Operator 407 visually locates serial number 404 on spraybar assembly 402 and enters it at the CALIBRATION UNIT 406.

B. CALIBRATION UNIT 406 excites spraybar valves 403, analyzes valve response, and generates correction data.

C. CALIBRATION UNIT 406 transfers spraybar serial number 404 and corresponding correction data to CENTRAL CONTROL SYSTEM/DATABASE 410 via a data link.

D. Operator 407 enters printing press location 414 of the spraybar assembly 402 within system into the CENTRAL CONTROL SYSTEM/DATABASE 410.

E. CENTRAL CONTROL SYSTEM/DATABASE 410 downloads correction data to SPRAYBAR CONTROLLER 412 at printing press location 414.

F. During operation, SPRAYBAR CONTROLLER 412 applies modified electrical signals to the nozzles 403 of the spraybar assembly 402 based on the corresponding correction data.

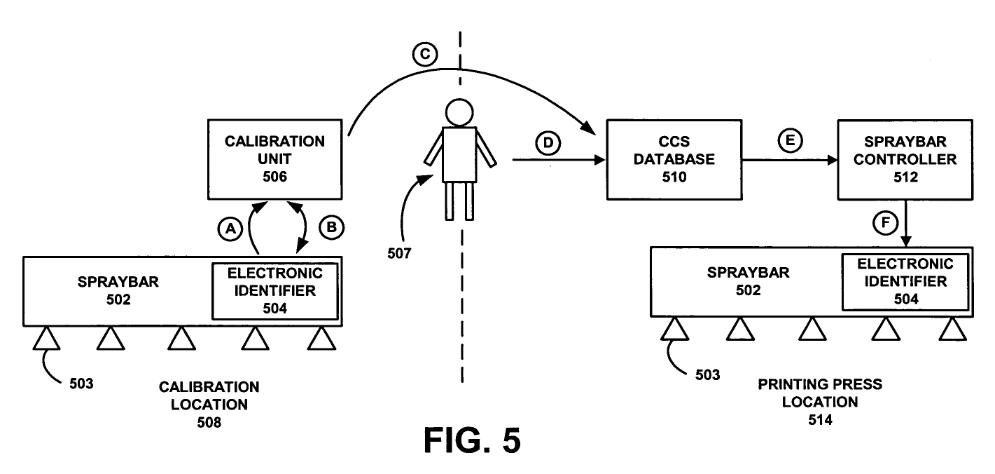

FIG. 5 depicts a further embodiment of the spraybar assembly implementation according to the present method and apparatus. This method is similar to the FIG. 3 method, except that each spraybar assembly 502 is equipped with a unique ELECTRONIC IDENTIFIER, for example a radio frequency identifier, 504 and a means of reading this identification exists at the calibration unit 506. This eliminates the need to enter an identifier manually.

As previously described, the spraybar assembly 502 may have a plurality of valves 503. At a calibration location 508 the calibration unit 506 is operatively coupled to the spraybar assembly 502 having an electronic identifier 504. The CENTRAL CONTROL SYSTEM/DATABASE 510 may be operatively coupled to a respective spraybar controller 512 that operates the spraybar 502 in the printing press location 514.

The sequence of events is:

A. CALIBRATION UNIT 506 reads ELECTRONIC IDENTIFIER 504 aboard spraybar assembly 502.

B. CALIBRATION UNIT 506 excites spraybar valves 503, analyzes valve response, and generates correction data.

C. CALIBRATION UNIT 506 transfers spraybar identification from the electronic identifier 504 and corresponding correction data to CENTRAL CONTROL SYSTEM/DATABASE 510 via a data link.

D. Operator 507 enters printing press location 514 of the spraybar assembly 502 within system into CENTRAL CONTROL SYSTEM/DATABASE 510.

E. CENTRAL CONTROL SYSTEM/DATABASE 510 downloads correction data to SPRAYBAR CONTROLLER 512 at printing press location 514.

F. During operation, SPRAYBAR CONTROLLER 512 applies modified electrical signals to the nozzles 503 of the spraybar assembly 502 based on the corresponding correction data.

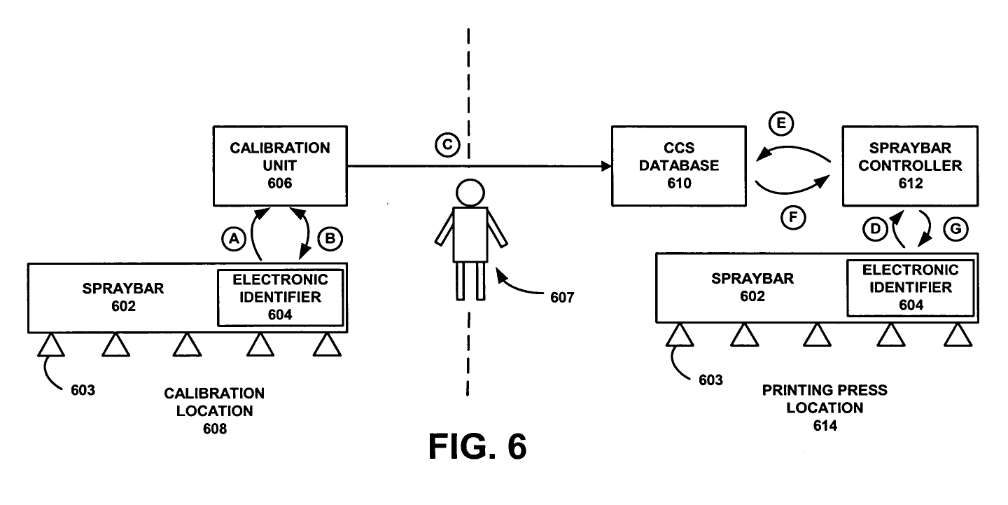

FIG. 6 depicts yet another embodiment of the spraybar assembly implementation according to the present method and apparatus. This method is similar to the FIG. 3 method, except that each SPRAYBAR CONTROLLER 602 may have the capacity to read the respective ELECTRONIC IDENTIFIER 604. This eliminates the need to manually enter the location of the spraybar assembly 602 within the dampening system. The operator 607 is still present to move the spraybar assembly 602 from the calibration location 608 to the printing press location 614.

As previously described, the spraybar assembly 602 may have a plurality of valves 603. At a calibration location 608 the calibration unit 606 is operatively coupled to the spraybar assembly 602 having an electronic identifier 604. The CENTRAL CONTROL SYSTEM/DATABASE 610 may be operatively coupled to a respective spraybar controller 612 that operates the spraybar 602 in the printing press location 614.

The sequence of events is:

A. CALIBRATION UNIT 606 reads ELECTRONIC IDENTIFIER 604 aboard spraybar assembly 602.

B. CALIBRATION UNIT 606 excites spraybar valves 603, analyzes valve response, and generates correction data.

C. CALIBRATION UNIT 606 transfers spraybar identification from the electronic identifier 604 and corresponding correction data to CENTRAL CONTROL SYSTEM/DATABASE 610 via a data link.

D. SPRAYBAR CONTROLLER 612 reads ELECTRONIC IDENTIFIER 604 aboard spraybar assembly 602.

E. CENTRAL CONTROL SYSTEM/DATABASE 610 receives spraybar identification from SPRAYBAR CONTROLLER 612.

F. CENTRAL CONTROL SYSTEM/DATABASE 610 downloads correction data to SPRAYBAR CONTROLLER 612 at printing press location 614.

G. During operation, SPRAYBAR CONTROLLER applies modified electrical signals to the nozzles 603 of the spraybar assembly 602 based on the corresponding correction data.

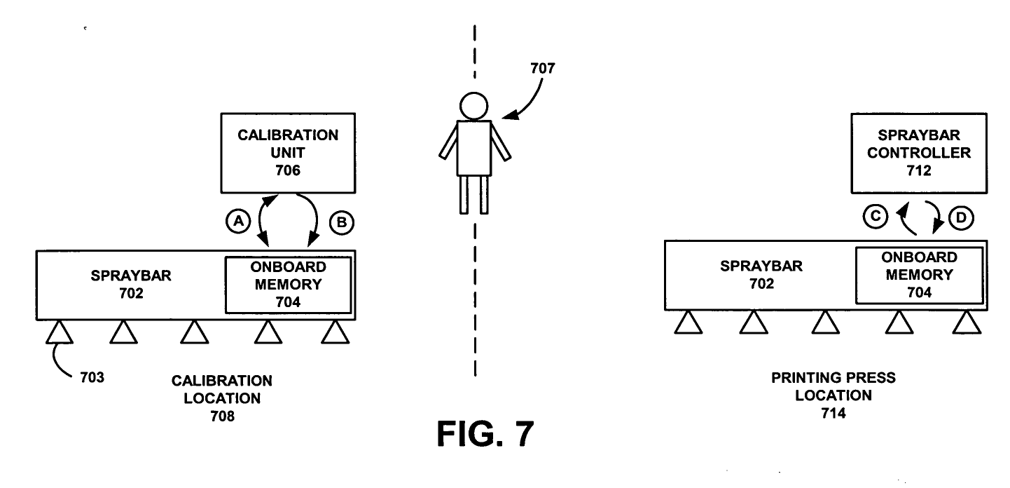

FIG. 7 depicts an additional embodiment of the spraybar assembly implementation according to the present method and apparatus. In this preferred embodiment, the identification and correction data may be stored in a non-volatile memory 704 aboard the spraybar assembly 702. The calibration unit 706 downloads correction data and identification to the non-volatile memory 704 aboard the spraybar assembly 702.

As previously described, the spraybar assembly 702 may have a plurality of valves 703. At a calibration location 708 the calibration unit 706 is operatively coupled to the spraybar assembly 702 having a non-volatile memory 704. A respective spraybar controller 712 operates the spraybar assembly 702 in the printing press location 714.

The sequence of events is:

A. CALIBRATION UNIT 706 excites spraybar valves 703, analyzes valve response, and generates correction data.

B. CALIBRATION UNIT 706 transfers correction data to ONBOARD MEMORY 704 on spraybar assembly 702.

C. SPRAYBAR CONTROLLER 712 reads ONBOARD MEMORY 704 uploading spraybar identification and correction data.

D. During operation, SPRAYBAR CONTROLLER 712 applies modified electrical signals to the nozzles 703 of the spraybar assembly 702 based on the corresponding correction data.

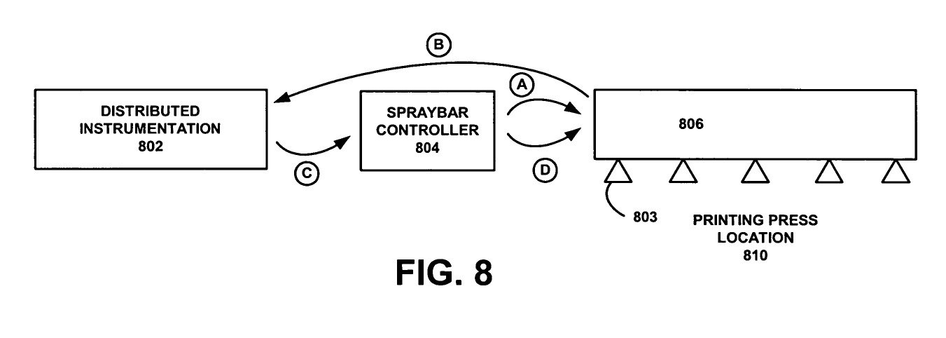

FIG. 8 depicts a further embodiment of the spraybar assembly implementation according to the present method and apparatus. This variation of the calibration concept involves migrating the measurement and analysis of the calibration apparatus onto the printing press in one or more locations. As such, the system is capable of continuous, automatic self-analysis and correction, without any operator intervention.

As previously described, the spraybar assembly 806 may have a plurality of valves 803. A respective spraybar controller 804 operates the spraybar assembly 802 in the printing press location 810. Distributed instrumentation 802 is operatively coupled to the spraybar controller 804 and to the spraybar assembly 806.

The sequence of events is:

A. SPRAYBAR CONTROLLER 806 excites spraybar valves 803.

B. DISTRIBUTED INSTRUMENTATION 802 senses response to excitation.

C. DISTRIBUTED INSTRUMENTATION 802 delivers feedback to SPRAYBAR CONTROLLER 804.

D. SPRAYBAR CONTROLLER 804 generates correction data based on received feedback, and during operation, SPRAYBAR CONTROLLER 804 applies modified electrical signals to the nozzles 803 of the spraybar assembly 802 based on the corresponding correction data.

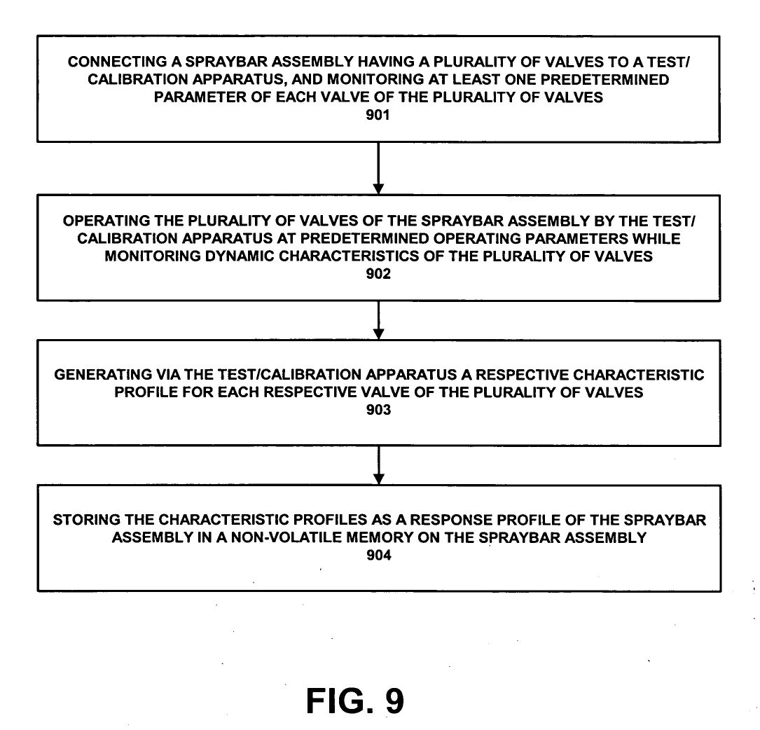

FIG. 9 is a flow diagram depicting in general an embodiment according to the present method. This embodiment of the present method may have the following steps: connecting a spraybar assembly having a plurality of valves to a test/calibration apparatus, and monitoring at least one predetermined parameter of each valve of the plurality of valves (step 901); operating the plurality of valves of the spraybar assembly by the test/calibration apparatus at predetermined operating parameters while monitoring dynamic characteristics of the plurality of valves (step 902); generating via the test/calibration apparatus a respective characteristic profile for each respective valve of the plurality of valves (step 903); and storing the characteristic profiles as a response profile of the spraybar assembly in a non-volatile memory on the spraybar assembly (step 904).

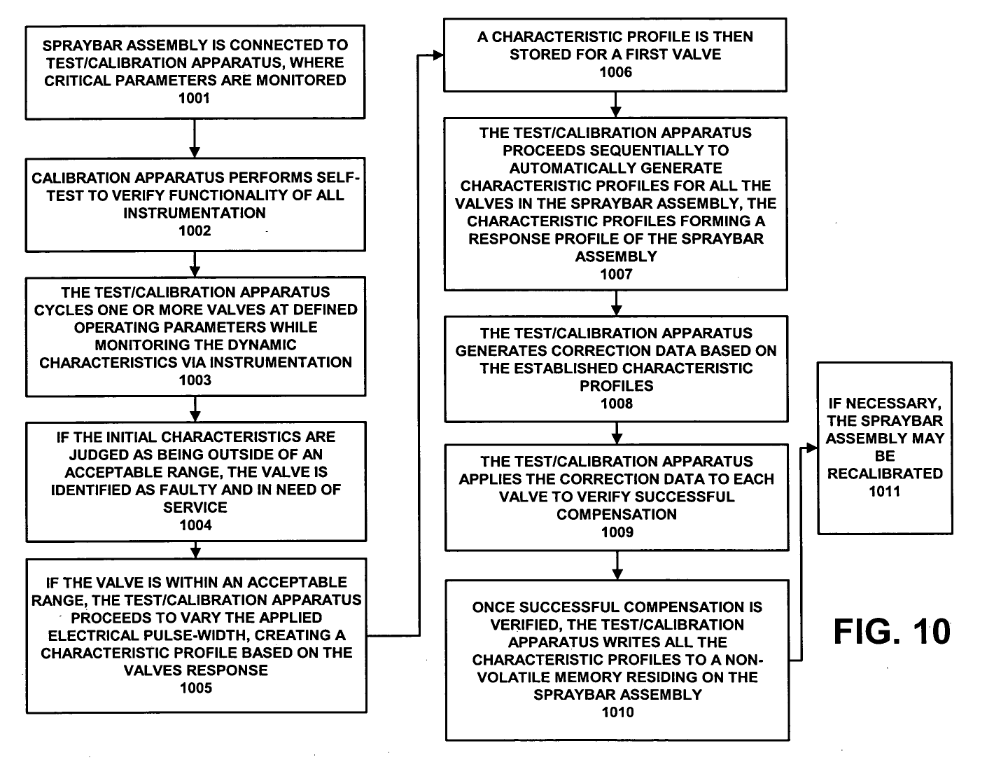

FIG. 10 is a flow diagram depicting in general an embodiment according to the present method during a calibration phase. In this embodiment the method may the following steps:

Spraybar assembly is connected to test/calibration apparatus, where critical parameters are monitored (step 1001).

Calibration apparatus performs self-test to verify functionality of all instrumentation (step 1002).

The test/calibration apparatus cycles one or more valves at defined operating parameters while monitoring the dynamic characteristics via instrumentation (step 1003).

If the initial characteristics are judged as being outside of an acceptable range, the valve is identified as faulty and in need of service (step 1004).

If the valve is within an acceptable range, the test/calibration apparatus proceeds to vary the applied electrical pulse-width, creating a characteristic profile based on the valves response. Although this embodiment varies the applied electrical pulse-width, several parameters, such as frequency or pressure could also be used to develop a response profile. Alternately, the test/calibration apparatus may modify the operating parameters until the valve's response is equal to a predetermined standard for the existing conditions (pressure, temperature, etc. . . . ) (step 1005).

A characteristic profile is then stored for a first valve (step 1006).

The test/calibration apparatus proceeds sequentially to automatically generate characteristic profiles for all the valves in the spraybar assembly, the characteristic profiles forming a response profile of the spraybar assembly (step 1007).

The test/calibration apparatus generates correction data based on the established characteristic profiles (step 1008).

The test/calibration apparatus applies the correction data to each valve to verify successful compensation (step 1009).

Once successful compensation is verified, the test/calibration apparatus writes all the characteristic profiles to a non-volatile memory residing on the spraybar assembly (step 1010).

If necessary, the spraybar assembly may be recalibrated (step 1011).

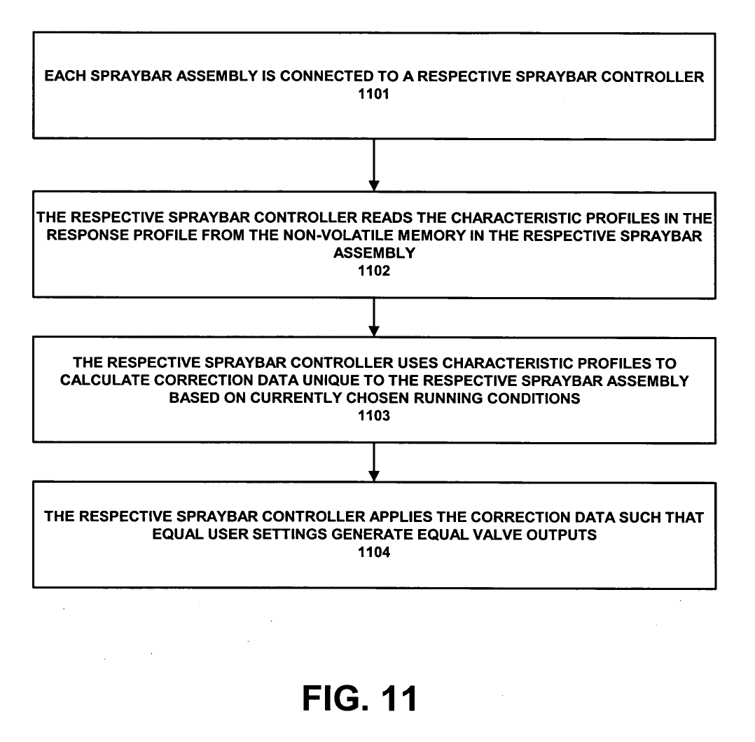

FIG. 11 is a flow diagram depicting in general an embodiment according to the present method during an operation phase. In this embodiment the method may the following steps:

Each spraybar assembly is connected to a respective spraybar controller (step 1101).

The respective spraybar controller reads the characteristic profiles in the response profile from the non-volatile memory in the respective spraybar assembly (step 1102).

The respective spraybar controller uses characteristic profiles to calculate correction data unique to the respective spraybar assembly based on currently chosen running conditions (step 1103).

The respective spraybar controller applies the correction data such that equal user settings generate equal valve outputs (step 1104).

The present method and apparatus may be incorporated in a many other embodiments than just those depicted in this disclosure. For example, the spraybar controller may be internal to the spraybar assembly. In such embodiments, the spraybar controller remains with the spraybar assembly when it is moved from one location to another.

The steps or operations described herein are just some examples of the present method and apparatus. There may be many variations to these steps or operations without departing from the spirit of the invention. For instance, the steps may be performed in a differing order, or steps may be added, deleted, or modified.

Although embodiments of the present method and apparatus have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a spraybar assembly having a plurality of spray valves;
a unique identification associated with the spraybar assembly;
response profile having a plurality of characteristic profiles, characteristic profiles of the plurality of characteristic profiles correspondingly respectively to spray valves of the plurality of spray valves; and
the response profile being associated with the spraybar assembly.

2. The apparatus according to claim 1, wherein the spraybar assembly has a non-volatile memory in which is stored the response profile.

3. The apparatus according to claim 1, wherein the unique identification is a serial number type designation.

4. The apparatus according to claim 1, wherein the unique identification is an electronic identifier.

5. The apparatus according to claim 1, wherein the apparatus further comprises a spraybar controller operatively coupled to the spraybar assembly, the spraybar controller having an input that receives the response profile and an output that provides electrical signals to the spray valves on the spraybar assembly, the spraybar controller using the response profile to form correction data that is used to modify the electrical signals.

6. The apparatus according to claim 5, wherein the spraybar assembly has a non-volatile memory in which is stored the response profile, and wherein spraybar controller reads the non-volatile memory to obtain the characteristic profiles in the response profile.

7. The apparatus according to claim 1, wherein the apparatus further comprises:
a spraybar controller operatively coupled to the spraybar assembly;
a test/calibration apparatus that determines the response profile;
a central control system database in which is stored the response profile;
the spraybar controller having an input that receives the response profile for the spraybar from the central control system database and an output that provides electrical signals to the spray valves on the spraybar assembly, the spraybar controller using the response profile to form correction data that is used to modify the electrical signals.

8. The apparatus according to claim 7, wherein central control system database is operatively coupled to the test/calibration apparatus.

9. An apparatus, comprising:
a printing unit having a plurality of spraybar assemblies;
each of the spraybar assemblies having a respective plurality of spray valves;
unique identifications respectively associated with the spraybar assemblies;
location identifications in the printing unit respectively associated with the spraybar assemblies;
a respective response profile for each of the spraybar assemblies, a respective response profile having a plurality of characteristic profiles, characteristic profiles of the plurality of characteristic profiles correspondingly respectively to spray valves of the plurality of spray valves for a respective spraybar assembly.

10. The apparatus according to claim 9, wherein each of the spraybar assemblies has a respective non-volatile memory in which is stored the respective response profile for the respective spraybar assembly.

11. The apparatus according to claim 9, wherein a respective unique identification is a serial number type designation.

12. The apparatus according to claim 9, wherein a respective unique identification is an electronic identifier.

13. The apparatus according to claim 9, wherein the apparatus further comprises a plurality of spraybar controllers operatively coupled respectively to the plurality of spraybar assemblies, a respective spraybar controller of the plurality of spraybar controllers having an input that receives a respective response profile and an output that provides respective electrical signals to spray valves on a respective spraybar assembly, the respective spraybar controller using the respective response profile to form correction data that is used to modify the respective electrical signals.

14. The apparatus according to claim 13, wherein each of the spraybar assemblies has a respective non-volatile memory in which is stored the respective response profile for the respective spraybar assembly, and wherein each of the respective spraybar controllers reads a respective non-volatile memory to obtain the characteristic profiles in a respective response profile.

15. A method, comprising:
connecting a spraybar assembly having a plurality of valves to a test/calibration apparatus, and monitoring at least one predetermined parameter of each valve of the plurality of valves;
operating the plurality of valves of the spraybar assembly by the test/calibration apparatus at predetermined operating parameters while monitoring dynamic characteristics of the plurality of valves;
generating via the test/calibration apparatus a respective characteristic profile for each respective valve of the plurality of valves; and
storing the characteristic profiles as a response profile of the spraybar assembly in a non-volatile memory on the spraybar assembly.

16. The method according to claim 15, wherein the method further comprises varying at least one of applied electrical pulse-widt, frequency and pressure as operating parameters.

17. A method, comprising:
connecting a spraybar assembly to test/calibration apparatus;
cycling at least one valve of the spraybar at defined operating parameters while monitoring dynamic characteristics;
rejecting the at least one valve, if initial dynamic characteristics are outside of a predetermined range;
varying electrical signals to the at least one valve, if the initial dynamic characteristics are within the predetermined range, to form a characteristic profile of the at least one valve based on valve response; and
storing the characteristic profile in a response profile that is associated with the spraybar assembly.

18. The method according to claim 17, wherein the response profile is stored in a non-volatile memory on the spraybar assembly.

19. The method according to claim 17, wherein the method further comprises:
generating, via the test/calibration apparatus, correction data based on the characteristic profiles in the response profile of the spraybar assembly; and
applying, via the test/calibration apparatus, the correction data respectively to each valve to verify successful compensation of the respective valve.

20. The method according to claim 17, wherein the method further comprises initially performing, via the calibration apparatus, a self-test to verify functionality of the calibration apparatus.

21. The method according to claim 17, wherein the method further comprises varying at least one of applied electrical pulse-width, frequency, pressure, voltage, current air supply, and solution supply as operating parameters.

22. The method according to claim 17, wherein the method further comprises modifying the operating parameters until a response of a respective valve is equal to a predetermined standard for the operating parameters.

23. A method, comprising:
connecting each spraybar assembly to a respective spraybar controller in a printing unit;
reading characteristic profiles in the response profile of a respective spraybar controller from a non-volatile memory in the respective spraybar assembly;
using, via the respective spraybar controller, characteristic profiles to calculate correction data unique to the respective spraybar assembly based on currently chosen running conditions of the printing unit; and
applying, via the respective spraybar controller, the correction data to modifying electrical signals to valves of the spraybar assembly such that equal user settings generate equal valve outputs.

24. The method according to claim 23, wherein the method further comprises operating a plurality of spraybar assemblies in the printing unit, and wherein each of the spraybar assemblies receives respective correction data independently of one another.
